(19) United States
(12) Patent Application Publication
(10) Pub. No.: US 2008/0092434 A1
(43) Pub. Date: Apr. 24, 2008

(54) METHOD TO INHIBIT SEPARATION OF OIL FROM WAX

(75) Inventors: Rob Milofsky, Durango, CO (US); Bruce Neal Stevens, Durango, CO (US)

Correspondence Address: William Denberg, 3195 W. Mockingbird Lane, Tucson, AZ, 85713, US

(73) Assignee: S & S Chemical, Durango, CO (US)

(21) Appl. No.: 11/551,722

(22) Filed: Oct. 22, 2006

(51) Int. Cl. C11C 5/00

(52) U.S. Cl. 44/275

(57) ABSTRACT

The discovery of an additive that inhibits the separation of liquid enhancing oils from wax objects such as candles is provided. The additive is derived from carboxylic acids having from about 6 to about 40 carbon atoms, preferably a combination of two such acids, and a partially hydrogenated oil or fat with an iodine value from about 0.5 to 20 and a melting point between about 100° and 200° F. The additive improves mottling and helps solve the problem of preserving the mottled appearance of the candle by inhibiting liquid enhancing oils such as fragrances and dyes from separating or bleeding out at room temperature or at significantly higher temperatures such as might be reached, for example, in a hot warehouse or during summertime transit in a truck. The additive also helps solve the problem of candles bleeding in the mold, thus reducing mold clean-up and maintenance costs. In addition, the additive promotes more efficient burning by uniformly dispersing the oil throughout the candle, and also increases the fragrance of the candle at room temperature (cold throw) and when burning (warm throw).

This application claims the benefit of Provisional Application No. 60/30,073, filed on Oct. 25, 2005, on behalf of applicants Robert Milofsky and Bruce Neal Stevens.

### FIELD OF THE INVENTION

The invention relates to methods and additives for inhibiting the separation of oils from wax objects and improving their stability and appearance, and most particularly relates, in one non-limiting embodiment, to methods and additives for inhibiting the separation of oils from wax candles.

### BACKGROUND OF THE INVENTION

Modern candles are primarily made from paraffin, vegetable oil or animal fat waxes. Paraffin wax is obtained as a by-product of petroleum refining operations. Paraffin waxes are generally white, translucent, tasteless, and odorless solids consisting of a mixture of solid hydrocarbons of relatively high molecular weight. Vegetable oil used in making wax is defined as esters of glycerin and a varying blend of fatty acids, which are insoluble in water but soluble in organic solvents. Animal fat used in making wax is defined as any fat obtained from animals and which is usually high in saturated fatty acids.

The aesthetic appeal of wax can be increased by adding enhancing oils, such as fragrances, essential oils, UV inhibitors, and coloring oils, which provide a pleasing scent, aroma and/or color. Powdered dyes are also used to color the wax, although typically they are solubilized in an oil solvent that is blended with the wax.

There is a limit to the amount of enhancing oils that may be added to a wax candle before separation of the oil occurs at room temperature, or at higher temperatures such as during summertime storage or transit. Oil separation is undesirable because it removes the oil from the candle making it unavailable for scenting the air, mars the appearance of the candle and makes it unattractive for sale—particularly if the oil is carrying dye, and creates a nuisance that must be cleaned up. Typically, the oil “bleeds” out of the surfaces of the candle in a relatively short amount of time.

The problem of separation of enhancing oils is particularly aggravated in mottled candles. Mottling of waxes has been used to produce a variety of different textures and appearances in candles.

To achieve the mottling appearance on the candle surface, a fragrance oil and/or dye oil is generally used, although mineral oil or soft wax components which are liquid at room temperature may be used, and some form of liquid phase should be present. Relatively slow cooling of the candle is also generally necessary for mottling to occur on the candle surface. For example, if paraffin wax is melted at 75° C. (167° F.) and mixed with 5 wt % commercially available fragrance and/or dye and then slowly cooled to room temperature, mottling will occur. One non-limiting explanation for the mottling phenomenon is that wax crystals begin to nucleate at about 60° C., leading to the production of larger, needle-like crystals that grow in breadth and length as crystallization progresses. At the solid-solid transition point of about 40° C., the point at which solid wax re-crystallizes, contractions in the crystalline boundaries are thought to cause micro-cracks and bubbles. A vapor phase, which may be air, propagates through the wax during this solid transition displacing the liquid oils in the crystalline interstices. Mottling occurs as larger gaps occur between crystals. Light refraction at the crystal surfaces gives a white snowflake pattern characteristic of mottling. Increasing the liquid phase reduces the cohesive forces between crystals thereby permitting the creation of more voids causing increased mottling.

To obtain highly fragranced, deeply colored, and mottled candles, it is necessary to use liquid additives, particularly liquid oil additives (oil additives liquid at ambient temperature). Paraffin with a high oil content will mottle but this is not a common commercial practice. These enhancing oils, however, tend to undesirably separate from the wax at room temperature and higher temperatures.

Thus, it would be desirable if some technique or additive could be provided that would prevent or inhibit the separation of liquid enhancing oils from waxes and yet would encourage or not inhibit a mottling effect.

U.S. Pat. No. 4,239,546 issued to Russell, et al. on Dec. 16, 1980 describes the use of hydrocarbon polymers to improve the hardness of waxes. An improvement in this process is described in U.S. Pat. No. 6,776,808 issued to Foster on Aug. 17, 2004, which provides a candle that has a limited ability to prevent separation of liquid oil, using branched poly-olefins as additives. However, it is not as effective as desired at inhibiting bleeding, providing mottling effects pleasing to consumers, or providing fragrance when burning (warm throw) or not (cold throw). Candles which use additives made from the prior art also tend to leave a lot of unbound oils in molds, resulting in a mess to clean. Thus a more effective product is needed to inhibit bleeding, improve mottling, provide more fragrance when burning or cold, and which has a higher melt point than existing products, so that it will remain solid during storage, be easier to work with and cause less clean-up problems when removing candles from molds.

All publications referred to herein are incorporated by reference to the extent not inconsistent herewith.

### SUMMARY OF THE INVENTION

A method is provided for forming wax objects, such as candles, which contain enhancing oils, in which there is a reduced tendency for the enhancing oil to separate from the wax. Enhancing oils are oils used to enhance or provide a desirable property of the object, such as scent, color, UV inhibition, or greater mottling.

The invention also provides a method for making a candle or other wax object containing an oil that is normally liquid at room temperature, where the oil is inhibited from separating from the wax when the object is stored at room temperature or higher, such as during summertime shipping and storage.

The invention is particularly addressed to wax objects where a fragrance and an appearance effect are coupled in the same object.

The invention also improves the mottling effect, providing a more attractive candle or other wax object through uniform dispersion and capture of the enhancing oil, thus promoting more efficient burning and release of the enhancing oil.

The invention also provides a method for making a candle or other wax object with improved cold and warm throw, i.e., more fragrance is given off at room temperature, and when burning.

There is provided, in one form, a method of making a wax object by combining a wax with at least one enhancing oil that is liquid at ambient temperature, and an amount of an additive effective to inhibit separation of the enhancing oil from the wax, wherein the additive comprises a carboxylic acid with enough carbon atoms to bind the oil, but not so many as to alter the crystalline structure of the wax and hence prevent mottling, for example, about 6 to about 40, and in one embodiment, about 8 to about 34 carbon atoms, or about 12 to about 22 carbon atoms, and a partially hydrogenated oil or fat with enough unsaturation to inhibit separation of the oil from the wax, but not so much as to alter the crystalline structure of the wax, for example, a partially hydrogenated oil or fat with an iodine value from 0.1 to 30 and a melting point between 100° and 200° F. and in one embodiment an iodine value from 0.5 to 20 and a melting point between 100° and 160° F. In one embodiment the partially hydrogenated oil or fat is partially hydrogenated soybean oil with an iodine value from about 0.6 to about 5.0 and a melting point between about 150° and about 170° F.

In one embodiment, a combination of two or more carboxylic acids can be used, for example, palmitic and stearic acids.

It will be appreciated that while the inventive method may be used to make candles, it may also be used to make other commercially useful wax objects, such as those used in surfing, body-boarding and skating, and other wax objects containing an oil, where it is desired to prevent separation of the oil from the wax.

This invention provides a wax object, comprising an enhancing oil, and an additive with a melting point above typical storage or transit temperatures, e.g., about 120° F. or above. In one embodiment, the wax object has a mottled appearance.

In an embodiment which uses paraffin wax, at least about 50% of the paraffin wax is unbranched paraffin; in other embodiments at least about 60%, at least about 70% at least about 80% and at least about 90% of the paraffin wax is unbranched paraffin. The paraffin object also comprises an amount of an additive effective to inhibit separation of the enhancing oil from the paraffin wax, wherein the additive comprises a carboxylic acid, having about 6 to about 40 carbon atoms, or in other embodiments, about 8 to about 34, or about 12 to about 22 carbon atoms. The additive also comprises a partially hydrogenated oil or fat with an iodine value from about 0.1 to about 30, or in other embodiments about 0.2 to about 20, or about 0.6 to about 5.0 and a melting point between about 100° and 200° F. As is known to the art, the iodine value is an expression of the degree of unsaturation of a fat or oil. It is determined by measuring the amount of iodine which reacts with a natural or processed fat or oil under prescribed conditions.

In embodiments of the invention, the additive comprises a combination of at least about two carboxylic acids, such as palmitic and stearic acids. Other carboxylic acids useful in this invention are selected from the group consisting of lauric acid, myristic acid, arachic acid and behenic acid,

Some non-limiting examples of partially hydrogenated oils and fats are partially hydrogenated palm oils, partially hydrogenated cottonseed oils, partially hydrogenated coconut oils, partially hydrogenated soy oil, partially hydrogenated castor oils, partially hydrogenated tallow, partially hydrogenated lard, partially hydrogenated bovine fat, and partially hydrogenated chicken fat. A “partially hydrogenated” oil or fat, as known to the art, is one that has been lightly to moderately hydrogenated to shift the melting point to a higher temperature range and increase the stability of the oil.

Enhancing oils include fragrant oils, both essential oils derived from plants, and synthetic fragrance oils. Some non-limiting examples of fragrance oils include lavender, cinnamic aldehyde, sandalwood, pumpkin spice, vanilla, cinnamic alcohol, eugenol, geraniol, alpha amyl cinnamic alcohol, hydroxycitronellal, pumpkin pie, and fresh air. Enhancing oils also include dyes in oil form, including powdered dyes solubilized in oil. Enhancing oils also include those added to increase mottling, such as mineral oils, and enhancing oils used to inhibit the effects of UV radiation. Combinations of such enhancing oils may be used.

The wax object can comprise enhancing oil in amounts from about 0.1 to about 20 wt percent, more preferably from about 0.1 to about 15 wt %, and most preferably from about 0.1 to about 12 wt %.

The amount of additive in the object can range from about 0.1 to about 10.0 wt %, based on the total object weight, or in other embodiments from about 0.3 to about 7.5 wt %, or from about 0.4 to about 5 wt %.

In one embodiment, a wax object is provided comprising an enhancing oil; a paraffin wax with a melting point of about 120° degrees F. or above wherein at least 50% of the paraffin is unbranched paraffin; and an amount of an additive effective to inhibit separation of the oil from the paraffin wax, said additive comprising a combination of palmitic and stearic acids, and partially hydrogenated soybean oil with an iodine value from about 0.6 to about 5.0 and a melting point between about 150° F. and about 170° F.

In one embodiment, about 10% to about 90% by weight of the additive is composed of a combination of carboxylic acids, wherein said combination comprises about 10% to about 90% by weight palmitic acid, and about 10% to about 90% by weight stearic acid, and wherein about 10% to about 90% by weight of the additive is partially hydrogenated soybean oil with an iodine value from about 0.6 to about 5.0 and a melting point between about 150° F. and about 170° F.

It is understood that in this description all quantitative ranges include any and all ranges encompassed therein.

This invention also provides a method of making a wax object comprising an enhancing oil, said method comprising combining an enhancing oil; and an amount of an additive effective to inhibit separation of the enhancing oil from the wax, wherein the additive comprises a combination of two carboxylic acids, each having about 6 to about 40 carbon atoms, and a partially hydrogenated oil or fat with an iodine value from about 0.1 to about 30 and a melting point between about 100° and 200° F. In an embodiment the combining is conducted at a temperature between about 150° and about 200° F. In other embodiments, the combining is conducted at temperatures between about 170° and about 190° F. between about 160° and about 180° F. or between about 1700 and about 175° F., or any other temperature within the above stated ranges.

### DETAILED DESCRIPTION OF THE INVENTION

In the present method, it has been discovered that an additive made from carboxylic acids having from about 6 to about 40 carbon atoms, or in other embodiments, about 8 to about 34, or about 12 to about 22 carbon atoms, and a partially hydrogenated oil or fat with an iodine value from about 0.1 to about 30, or in other embodiments, about 0.2 to about 20, or about 0.6 to about 5.0 and a melting point between about 100° and 200° F., when added to a wax and a liquid enhancing oil helps prevent, retard, mitigate, reduce, control, delay or inhibit the separation, removal, division, isolation, severance, or partition of the enhancing oil from the wax at room temperature and at higher temperatures, such as during summertime storage and shipment.

As noted, when enhancing oils are included with waxes, they will often separate from the wax when the object is held at room temperature or above, even for relatively short periods of time (less than twenty-four hours).

The term “inhibiting” is used herein in a broad and general sense to mean any improvement in preventing, controlling, delaying, reducing or mitigating the separation, partitioning and/or removal of liquid components, especially liquid enhancing oil components in any manner, including, but not limited to, by dissolution, by breaking up, other mechanisms, or any combination thereof.

Although the term “inhibiting” is not intended to be restricted to the complete prevention of liquid separation, it may include the possibility that separation of any liquid is entirely prevented.

The nature of the paraffin wax used in the practice of this invention should be a paraffin with a melt point above about 120° F., and where at least about 50% of the wax is comprised of normal paraffins (alkanes).

With respect to the enhancing oil, the invention is effective with respect to most, if not all enhancing oils typically added to waxes, where the enhancing oil is liquid at ambient or higher temperatures, such as during summertime shipping and storage.

These liquid enhancing oils include, but are not limited to, essential oils, fragrances, oil-based dyes, mineral oils, UV inhibitors, and liquid oils used to provide other benefits in properties or appearance such as mottling, and the like. An essential oil is a volatile oil derived from the leaves, stem, flower, or twigs of plants, and usually carries the odor or flavor of the plant. Of course, more than one liquid enhancing oil may be used simultaneously, and often is in candles where a fragrance and a dye are employed together. In one non-limiting embodiment of the invention, the liquid enhancing oils are used in a total amount, based on the total weight of the object, in proportions ranging from about 0.1 to about 20 wt percent, more preferably from about 0.1 to about 15 wt %, and most preferably from about 0.1 to about 12 wt %.

The carboxylic acids used in this additive may be selected from the group of carboxylic acids having from about 6 to 40 Carbon atoms. In an embodiment, combinations of two or more carboxylic acids are used.

These carboxylic acids are combined with any partially hydrogenated oil or fat with an iodine value from about 0.1 to 30 and a melting point between about 1000 and 200° F.

In one non-limiting embodiment, palmitic and stearic acid are blended with partially hydrogenated soybean oil.

Optimization within the skill of the art may be necessary to specify with accuracy the proportion of additive to be used in a particular wax formulation to inhibit separation of the enhancing oil. The proportion of additive in a particular wax formulation depends upon a number of complex, interrelated factors including, but not necessarily limited to, the nature of the wax, the proportion and nature of the liquid enhancing oil additives, and the processing of the wax object, including, but not necessarily limited to, the initial melt temperature and the rate of cooling, among other factors.

In some non-limiting embodiments, the amount of partially hydrogenated oil or fat in the additive is from about 10.0 wt % to about 90.0 wt %, based on the total additive weight, and the amount of carboxylic acids range from about 10.0 wt % to about 90.0% wt., based on the total additive weight.

In other non-limiting embodiments, the carboxylic acids are palmitic and stearic acid in the ratio of about 55% palmitic acid to about 45% stearic acid, and the partially hydrogenated oil of the additive is partially hydrogenated soybean oil with an iodine value from about 0.6 to 5.0 and a melting point of about 170 to 190° F.

The additive is added to the wax in a range from about 0.1 wt % to about 10.0 wt % and most preferably about 1%, based on total weight.

It will be appreciated that a typical temperature for combining the components of wax objects within the method of this invention may range between about 150 and about 200° F., and most preferably about 180° F.

It will further be appreciated that in one non-limiting embodiment of the invention, it is not necessary that the separation of the enhancing oil from the wax is prevented, stopped or totally inhibited or controlled. The invention is considered to be successful and effective if separation is inhibited as compared with an otherwise identical wax object where the only difference is the absence of the additive.

The combining of the additive with the wax and enhancing oil may be achieved by a number of techniques, including, but not necessarily limited to, mixing or blending with mechanical mixing equipment, stationary mixing equipment, magnetic mixing equipment, or other suitable equipment known to one skilled in the art, and combinations thereof to provide adequate contact and/or dispersion of the components of the mixture. The various components of the composition may be added and mixed in any order.

In general, it has been demonstrated that this additive can be used in a candle application, particularly a mottled candle application using common commercial fragrances that yielded a final product that has none or significantly reduced migration of the enhancing oil to the surface of the wax. As noted, fragrance loads of candies have been typically limited due to oil bleed. Improved mottling and retention of the enhancing oil occurs with the addition of about 1% to 10% by weight of the additive, based on total candle weight.

Bleeding of the enhancing oil decreases and mottling improves as the percent of the additive is increased to about 1%. Above about 1%, the improvement in retention of the enhancing oil and mottling effect is modest up to about 10%. Beyond about 10%, no additional improvements are observed.

Without wishing to be bound by any theory of the mechanism by which the additive works, in one non-limiting explanation, the polar head groups of the carboxylic acids, along with the length of their non-polar tails, and some unsaturated fatty acids from the partially hydrogenated oil or fat interact to form a crystal lattice which traps and uniformly distributes the fragrance and/or coloring throughout the candle, and improves the mottling effect.

These additive ingredients also have melting points below or within the range of a burning candle, thereby allowing the uniform release of the oils.

It will be appreciated that the inventive method may be used to make other wax objects containing an oil where it is desired to prevent separation of the oil from the wax, for example in surfboard waxes, waxes used by in-line skaters and skateboarders on edges of structures used in tricks, and other waxes.

### EXAMPLES

The additive was prepared by mixing 70% by weight of a partially hydrogenated soybean oil in flake form (iodine value=0.6, melt point=159° F.) with a 30% by weight mixture composed of 55% palmitic acid and 45% stearic acid at 180° F. About 1% by weight of this additive was then mixed with IGI 1274A paraffin (from The International Group, Inc., Ontario, Canada) which had been melted to 200° F., and contained 0.06% by weight Spiced Pumpkin dye (from French Color & Fragrance Co., Englewood, N.J.) and 1% by weight UV inhibitor (from French Color & Fragrance Co.), and 10% by weight Pumpkin Pie fragrance (from French Color & Fragrance Co.). The mixture was placed in a candle mold and allowed to cool at room temperature resulting in a candle having a mottled appearance and exhibiting less bleeding than commercially available candles. Twenty other examples were prepared and are summarized in the tables below. In all cases, the method used was the same as in the example above, but different waxes, colors and fragrances were used. All colors and fragrances are from French Color & Fragrance Co., Englewood, N.J. The waxes used include Calwax 140-M for the first through fourth examples, available from the Calwax Corporation, Irwindale, Calif.; Accu-Blend AB-150 for the fifth through eighth examples, from the Accu-Blend Corporation, South El Monte, Calif.; Calwax 1010 for the ninth through twelfth examples; and IGI 1274 for the thirteenth through twentieth examples, from the International Group, Incorporated, of Ontario, Canada. “Drops per candle,” refers to drops from a standard medicine dropper, and “bloom,” is defined as a mottled white coating. As will be appreciated from these examples, when the additive is used, the degree of bleeding is greatly reduced and the aesthetic properties are enhanced.

| | | | | | | Degree of | Degree | Degree of |
|---|---|---|---|---|---|---|---|---|
| | | % | | Drops per | % Mottling | bleeding | Bloom | Blistering |
| % Additive | Fragrance added | Fragrance | Color added | candle | (0–10) | (0–10) | (0–10) | (0–10) |
| 0 | Jasmine | 8 | Apricot | 1 | 9 | 4 | 0 | 0 |
| 1% | Jasmine | ″ | ″ | ″ | 8 | 0 | 0 | 0 |
| 0 | Vanilla | ″ | ″ | ″ | 7 | 7 | 1 | 1 |
| 1% | Vanilla | ″ | ″ | ″ | 8 | 0 | 0 | 0 |
| 0 | Christmas tree | 8 | Green | 1 | 9 | 8 | 0 | 2 |
| 1% | Christmas tree | ″ | ″ | ″ | 8 | 1 | 0 | 3 |
| 0 | Blueberry/lemon | ″ | ″ | ″ | 4 | 8 | 4 | 6 |
| 1% | Blueberry/lemon | ″ | ″ | ″ | 6 | 1 | 2 | 0 |
| 0 | Jasmine | 8 | Purple | 1 | 5 | 10 | 0 | 0 |
| 1% | Jasmine | ″ | ″ | ″ | 4 | 3 | 0 | 0 |
| 0 | Mango/papaya | ″ | ″ | ″ | 9 | 7 | 0 | 0 |
| 1% | Mango/papaya | ″ | ″ | ″ | 9 | 1 | 0 | 0 |
| 0 | Jasmine | 8 | Red | 1 | 6 | 10 | 7 | 0 |
| 1% | Jasmine | ″ | ″ | ″ | 5 | 2 | 3 | 0 |
| 0 | Blueberry/lemon | ″ | ″ | ″ | 4 | 10 | 8 | 3 |
| 1% | Blueberry/lemon | ″ | ″ | ″ | 3 | 4 | 3 | 0 |
| 0 | Pumpkin spice | ″ | ″ | ″ | 7 | 6 | 4 | 0 |
| 1% | Pumpkin spice | ″ | ″ | ″ | 6 | 2 | 3 | 0 |
| 0 | Christmas tree | ″ | ″ | ″ | 7 | 3 | 4 | 0 |
| 1% | Christmas tree | ″ | ″ | ″ | 7 | 1 | 5 | 0 |

Many modifications may be made in the composition and implementation of this invention without departing from the spirit and scope thereof that are defined only in the appended claims. For example, exact combinations of liquid enhancing oils and the additive may be different from those exemplified here. Further carboxylic acids/partially hydrogenated oil or fat combinations different from those discussed and exemplified are also expected to be useful in the inventive method and products.

1. A wax object comprising:
a wax;
an enhancing oil; and
an amount of an additive effective to inhibit separation of the enhancing oil from the wax, wherein the additive comprises:
a carboxylic acid, having about 6 to about 40 carbon atoms; and
a partially hydrogenated oil or fat with an iodine value from about 0.1 to about 30 and a melting point between about 100° and about 200° F.

2. The wax object of claim 1 having a mottled appearance.

3. The wax object of claim 1 wherein the wax is a vegetable oil wax.

4. The wax object of claim 1 wherein the wax is an animal fat wax.

5. The wax object of claim 1 wherein the wax is a paraffin wax with a melting point of about 120° F. or above wherein at least about 50% of the paraffin is unbranched paraffin.

6. The wax object of claim 1 wherein said carboxylic acid has about 12 to about 22 carbon atoms.

7. The wax object of claim 1 wherein the enhancing oil is selected from the group consisting of fragrant essential oils, synthetic fragrances, liquid oil dyes, and combinations thereof.

8. The wax object of claim 1 wherein the amount of enhancing oil in the object ranges from about 0.1 to about 20 wt %, and wherein the amount of additive in the object ranges from about 0.1 to about 10.0 wt %, based on the total object weight.

9. The wax object of claim 1 which is a candle.

10. The additive of claim 1 which is a pellet.

11. The wax object of claim 1 having a combination of at least about two carboxylic acids.

12. The wax object of claim 11 wherein said carboxylic acids are selected from the group consisting of lauric acid, myristic acid, palmitic acid, stearic acid, arachidic acid and behenic acid.

13. The wax object of claim 11 wherein said carboxylic acids are palmitic and stearic acids.

14. A wax object comprising:
a paraffin wax with a melting point of about 120° F. or above wherein at least about 50% of the paraffin is unbranched paraffin.
an enhancing oil;
an amount of an additive effective to inhibit separation of the oil from the wax, comprising:
a combination of palmitic and stearic acids, and
partially hydrogenated soybean oil with an iodine value from about 0.6 to about 5.0 and a melting point between about 150° F. and about 170° F.

15. The wax object of claim 14 which has a mottled appearance.

16. The wax object of claim 14 wherein the enhancing oil is selected from the group consisting of a fragrant essential oil, a synthetic fragrance, a liquid oil dye, and combinations thereof.

17. The wax object of claim 14 wherein the amount of enhancing oil in the object ranges from about 0.1 to about 20 wt %, and wherein the amount of additive in the object ranges from about 0.1 to about 10.0 wt %, based on the total object weight.

18. The wax object of claim 14 wherein about 10% to about 90% by weight of the additive is composed of a combination of carboxylic acids, wherein said combination comprises about 10% to about 90% by weight palmitic acid, and about 10% to about 90% by weight stearic acid, and wherein about 10% to about 90% by weight of the additive is partially hydrogenated soybean oil.

19. The wax object of claim 14 which is a candle.

20. The additive of claim 14 which is a pellet.

21. A method of making a wax object comprising an enhancing oil, said method comprising combining:
a wax;
an enhancing oil; and
an amount of an additive effective to inhibit separation of the enhancing oil from the wax, wherein the additive comprises a combination of two carboxylic acids, each having about 6 to about 40 carbon atoms; and
a partially hydrogenated oil or fat with an iodine value from about 0.1 to about 30 and a melting point between about 100° F. and 200° degrees F.

22. The method of claim 21 which produces a wax object with a mottled appearance.

23. The method of claim 21 wherein the enhancing oil is selected from the group consisting of fragrant essential oils, synthetic fragrances, liquid oil dyes, and combinations thereof.

24. The method of claim 21 wherein the amount of enhancing oil in the object ranges from about 0.1 to about 20 wt %, and wherein the amount of additive in the object ranges from about 0.1 to about 10.0 wt. %, based on the total object weight.

25. The method of claim 21 wherein the combining is conducted at a temperature between about 150° and about 200° F.

26. The method of claim 21 where the wax is a paraffin wax with a melting point of about 120° F. or above wherein at least about 50% of the paraffin is unbranched paraffin.

27. The method of claim 21 wherein the wax is a vegetable oil wax.

28. The method of claim 21 wherein the wax is an animal fat wax.

29. A method of making a wax object having a mottled appearance, said method comprising combining:
a paraffin wax with a melting point of about 120° F. or above wherein at least about 50% of the paraffin is unbranched paraffin.
an enhancing oil; and
an amount of an additive effective to inhibit separation of the oil from the wax, wherein the additive comprises:
a combination of palmitic and stearic acids; and
partially hydrogenated soybean oil with an iodine value from about 0.6 to about 5.0 and a melting point between about 150° and about 170° F.

30. The method of claim 29 wherein the enhancing oil is selected from the group consisting of fragrant essential oils, synthetic fragrance, liquid oil dyes, and combinations thereof.

31. The method of claim 29 wherein the amount of enhancing oil in the object ranges from about 0.1 to about 20 wt %, and wherein the amount of additive in the object ranges from about 0.1 to about 10.0 wt %, based on the total object weight.

32. The method of claim 29 where the combining is conducted at a temperature between about 170° and about 1900 degrees F.

33. The method of claim 29 wherein about 10% to about 90% by weight of the additive is composed of about 10 to about 90% by weight palmitic acid, and about 10% to about 90% by weight stearic acid, and wherein about 10% to about 90% by weight of the additive is partially hydrogenated soybean oil.
